(19) United States
(12) Patent Application Publication
(10) Pub. No.: US 2007/0015842 A1
(43) Pub. Date: Jan. 18, 2007

(54) Glass fiber reinforced polyurethane/polyisocyanurate foam

(76) Inventors: Marc Moerman, Saint-Remy-Les-Chevreuse (FR); Bruno Guelton, Ecoqueneauville (FR); Jacques Dhellemmes, Versailles (FR)

Correspondence Address: YOUNG & THOMPSON, 745 SOUTH 23RD STREET, 2ND FLOOR, ARLINGTON, VA, 22202, US

(21) Appl. No.: 11/348,273

(22) Filed: Feb. 7, 2006

(30) Foreign Application Priority Data
Mar. 4, 2005 (FR) 05 02227
Oct. 28, 2005 (FR) 05 11111

(51) Int. Cl. C08J 9/00

(52) U.S. Cl. 521/82

(57) ABSTRACT

A glass fiber reinforced polyurethane/polyisocyanurate foam obtained by: 1) contacting: an isocyanate component, a polyol component including a first polyol, a second polyol, and a third polyol, in the presence of: catalysts, a physical or chemical blowing agent, an emulsifier, and optionally a flame retardant, 2) impregnating, with the formulation obtained from step 1, a glass fiber stack, and 3) expanding and solidifying the formulation to form a reinforced foam block containing the glass fiber stack; the reinforced foam block having an average density of between 115 and 135 kg/m³, and an isocyanate index of between 100 and 180.

The present invention relates to a rigid poly-urethane/polyisocyanurate (PUIR) foam reinforced with glass fibers, to a process for producing it, and to its use as an insulating material for liquefied gas transport tanks, and especially liquefied gas tanker tanks.

European patents 248 721 and 573 327 in particular disclose insulating elements for liquefied gas transport tanks which are used in liquefied gas tankers and are composed of plywood boxes filled with a polyurethane foam insulant. The insulating elements are distributed in two insulating barriers, referred to as primary and secondary insulating layers. These insulating elements impart satisfactory thermal insulation, but necessitate a substantial setting time, since the boxes making up each primary and secondary layer must not only be fastened to the tank but be fixed to one another in order to constitute the different thermal insulation layers.

Furthermore, numerous rigid polyurethane (PU) foams have been developed for uses as insulation material. This type of material exhibits satisfactory thermal insulation characteristics for such use, and remains easy to handle and to install. However, unless incorporated into plywood boxes, PU foams are unsuitable for the thermal insulation of liquefied gas tanker tanks, since they lack mechanical strength characteristics, of the compressive strength and tensile strength type, which are sufficient to resist the pressure of the liquefied gas in motion in the tank, or the sharp variations in temperature.

Moreover, this type of material generally incorporates, as blowing agent, gases which are relatively harmful to the environment, particularly the hydrochlorofluoro-carbon HCFC 141b, whose use has been prohibited in Europe as of Jan. 1, 2004.

This type of gas is replaced advantageously by hydrocarbons such as pentane or isopentane. The latter, however, are still gases which are highly flammable. Moreover, using such hydrocarbons would prevent any detection of gas leaks from the liquefied gas transport tank.

The object of the invention is to provide a foam which avoids the aforementioned drawbacks and which exhibits not only good thermal insulation characteristics and mechanical characteristics in the form of Z compressive strength (that is, compressive strength in the direction of the thickness of the foam) under heat (20° C.) and under cold (−170° C.) but also mechanical characteristics in the form of Y tensile strength (that is, tensile strength in the direction of the length of the foam) under heat and under cold which are satisfactory, these characteristics allowing it in particular to be used as a thermal insulating material for liquefied tanker tanks.

The invention provides a glass fiber reinforced polyurethane/polyisocyanurate foam obtained by:
1) contacting:
   an isocyanate component having a viscosity of between 200 and 600 mPa.s,
   a polyol component comprising a first polyol, a second polyol, and a third polyol, said polyols having a viscosity of between 200 and 6000 mPa.s, in the presence of:
   catalysts selected from tin salts, potassium carboxylates, and, optionally, tertiary amines,
   a physical and/or chemical blowing agent,
   an emulsifier, and
   optionally a flame retardant,
2) impregnating, with the formulation obtained from step 1, a glass fiber stack, optionally in the form of mats, and optionally associated by a binder and
3) expanding and solidifying said formulation to form a reinforced foam block containing the glass fiber stack;
   said reinforced foam block having an average density of between 115 and 135 kg/m³, preferably between 120 and 130 kg/m³, more advantageously around 130 kg/M³, and an isocyanate index of between 100 and 180, preferably between 130 and 180.

According to one feature of the present invention said isocyanate component is methylenediphenyl diisocyanate (MDI) having an average functionality of between 2.5 and 3.5, preferably between 2.9 and 3.1.

According to another feature of the invention said first polyol is a sorbitol derivative, said second polyol is a polyether polyol, and said third polyol is a polyester polyol. Advantageously the polyether polyol is preferably a glycerol derivative and the polyester polyol is preferably aromatic.

Preferentially said polyol component is composed of said first, second, and third polyols, wherein said first polyol is present in proportions from 10% to 80% by mass relative to the mass of said polyol component, wherein said second polyol is present in proportions from 10% to 80% by mass relative to the mass of said polyol component, and wherein said third polyol is present in proportions from 10% to 80% by mass relative to the mass of said polyol component.

Advantageously the proportions by mass of the first, second, and third polyols relative to the mass of said polyol component are 60%, 20%, and 20% respectively.

The foam therefore, owing to the formulation of the invention, exhibits not only satisfactory thermal insulation characteristics but also, surprisingly, mechanical characteristics in the form of compressive strength and tensile strength which thus allow it to be used, where appropriate, as an insulating material for a liquefied gas tanker tank. Moreover, the formulation of the invention allows for complete and homogeneous impregnation of the glass fiber stack.

According to a second feature of the invention said catalysts are selected from tin salts and potassium carboxylates to the exclusion of tertiary amines. Thus in the foam of the invention it is possible to avoid the use of catalysts based on tertiary amines, which represents an advantage, since tertiary amines are irritant, and therefore inconvenient to handle, and are harmful to the environment.

According to a third feature of the invention said blowing agent is water. Accordingly, by virtue of this feature, it is no longer necessary to use gases such as the chlorofluorocarbons of type 141b which are harmful to the environment and have been prohibited in Europe as of Jan. 1, 2004, or highly flammable gases such as pentane. The reason for this is that the presence of water as a blowing agent brings about release of CO₂, which causes the foam to expand. C₂ has the advantage of being less harmful to the environment and of not being flammable.

According to one version said blowing agent is HCF-365mfc or HCF-245fa. Moreover, the use of HCF-365mfc and/or HCF-245fa may be combined with the use of water as a blowing agent.

According to another version said flame retardant is nonhalogenated. Accordingly, in contrast to a halogenated flame retardant, the incorporation of this type of flame retardant into a composition has no detrimental activity for the environment.

According to a first embodiment said glass fiber stack is in the form of a stack of glass fiber mats. The glass fiber mats are advantageously of the continuous strand mat (CSM) type.

Advantageously, in the first embodiment, the glass fibers have a linear density of 20 to 40 tex, preferably 30 tex.

According to a second embodiment, said glass fiber stack comprises continuous glass fibers manufactured from roving.

Preferentially, in the second embodiment, the glass fibers have a linear density of 30 to 300 tex.

Advantageously said continuous glass fibers are produced by a process comprising a step of separating continuous glass fiber roving whose linear density is less than that of the roving, by means, for example, of the Webforming process developed by Plastech T.T. Ltd. The second embodiment is more advantageous than the first, since it entails, to start with, improved wettability on the part of the glass fibers. The consequence of this feature is, to start with, more homogeneous impregnation of the glass fibers. Furthermore, the foam blocks according to the second embodiment also exhibit satisfactory mechanical properties in tension and in compression along all of the axes. Finally, the glass fibers come from roving spools or packages, which are easier to acquire and whose purchase cost is less than that of glass fiber mats.

According to one version of the first or second embodiment, said glass fibers are associated with one another by a binder.

Advantageously, in this variant embodiment, the amount of said binder is between 0.6% and 3%, preferably around 2.5% by mass of said glass fibers. This amount of binder is advantageous for the impregnation of the glass fibers to be uniform and complete.

Preferentially in the second embodiment said glass fibers are not associated by a binder. Hence, when a little (<0.6%) or no binder is used, the glass fibers are distributed more uniformly within the reinforced foam block, which gives the reinforced foam block better mechanical characteristics.

Advantageously, in all of the embodiments, the glass fibers are of E type.

Preferentially said glass fiber stack has a grammage of between 300 to 900 g/m², preferably 450 g/m².

In an advantageous version of the first or of the second embodiment, the glass fibers constitute 9% to 13%, preferably from 10% to 12% by mass relative to the total mass of the reinforced foam block.

The entirety of the aforementioned parameters relating to the glass fiber mats and the glass fibers themselves is also favorable to satisfactory impregnation of the glass fibers and has proven to give the foam satisfactory tensile strength (i.e., strength in elongation) characteristics.

Advantageously the flammability is in accordance with the DIN 4102-1 (B2) test.

According to one preferred embodiment the foam is in the form of a foam block with a thickness of between 20 and 35 cm. Accordingly, depending on the desired use, as an insulating material for example, a sufficient amount of formulation, of glass fibers, in the form where appropriate of mats, and of blowing agent will be defined so as to produce a foam block having a desired thickness. The advantage of producing foam blocks with a thickness of 20 cm is that, after trimming, the foam blocks can be used directly as a secondary insulating layer for a liquefied gas tanker, this layer customarily having a thickness of 18 cm, and/or can be cut transversely relative to their middle, in order to form, directly, a primary insulating layer for a liquefied gas tanker, this layer customarily having a thickness of 9 cm. Similarly, a foam block produced with a thickness of 30 cm will be able to form, after trimming and cutting to a third of its thickness, a 9 cm primary insulation layer and, simultaneously, an 18 cm secondary insulating layer.

The invention additionally provides a process for producing a glass fiber reinforced polyurethane/poly-isocyanurate foam, comprising the steps of:
1) contacting:
   an isocyanate component having a viscosity of between 200 and 600 mPa.s,
   a polyol component comprising a first polyol, a second polyol, and a third polyol, said polyols having a viscosity of between 200 and 6000 mPa.s, in the presence of:
   catalysts selected from tin salts, potassium carboxylates, and, optionally, tertiary amines,
   a blowing agent,
   an emulsifier,
   optionally a flame retardant,
2) impregnating, with the formulation obtained from step 1, a glass fiber stack, optionally in the form of mats, optionally associated with one another by a binder
3) causing said formulation to solidify after expansion, so as to form a foam block containing the glass fiber stack,
4) trimming the top, bottom, and, optionally, side parts of said foam block, and optionally
5) cutting said foam block transversely, to give a primary insulating layer and a secondary insulating layer.

Finally, the invention provides for the use of the foam in the thermal insulation of liquefied gas transport tanks, and especially liquefied gas tanker tanks.

In the detailed description which will follow, the term “PUIR” signifies “polyurethane/polyisocyanurate”. The term “low viscosity” signifies, for the isocyanate, a viscosity of between 200 and 600 mPa.s and, for the polyols, a viscosity of between 200 and 6000 mPa.s, all viscosity values being given for a temperature of 25° C. Finally, the term “PUIR index” denotes the molar ratio [(−NCO group of the polyisocyanurate/−OH group of the polyurethane)×100].

Lastly, in the description below, the term “glass fiber stack” denotes either a stack of glass fiber mats (first embodiment) or a stack of glass fibers produced from roving (second embodiment).

The invention will be better understood, and other objects, details, features, and advantages thereof will appear more clearly, in the course of the detailed, explanatory description below, of a number of embodiments of the invention, which are given as purely illustrative and nonlimitative examples, with reference in particular to the schematic drawings attached.

In these drawings, which illustrate one process for producing the glass fiber stack according to the second embodiment:

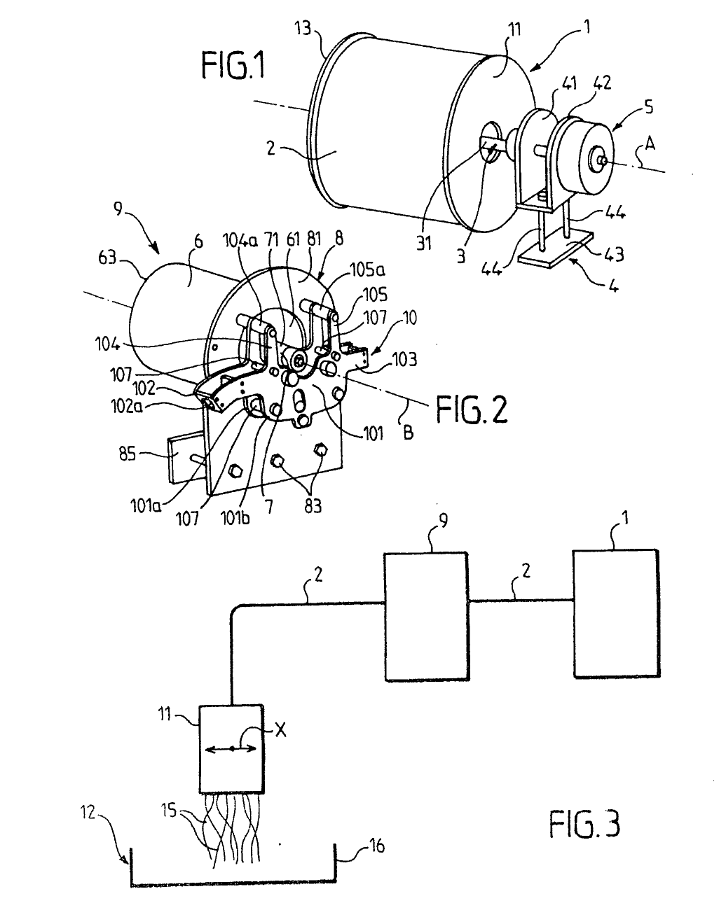

FIG. 1 is a perspective view of a roving spool, the roving being used as base material;

FIG. 2 is a perspective view of a supply capstan, the supply capstan being an intermediate element between the roving spool and the distributor head of the glass fibers; and

FIG. 3 is a perspective view of a glass fiber production line.

In accordance with the present invention the PUIR foam is formed by reaction of an isocyanate component and a polyol component composed of a polyols mixture. The reaction between these various compounds proceeds in accordance with the following four steps: 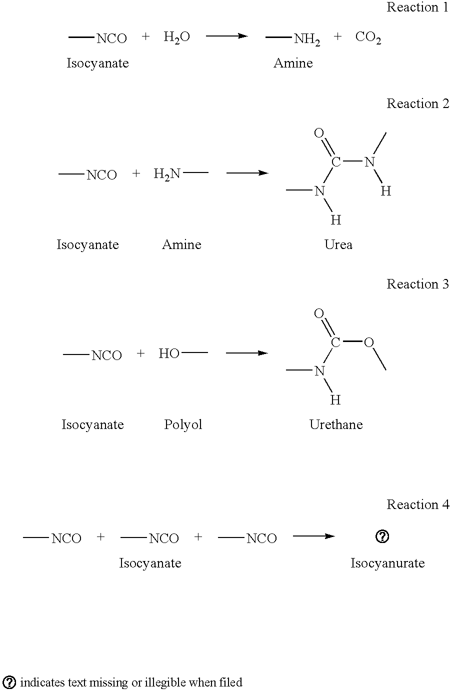
The first step, the initiation step, is the step in which the water molecules react with the −NCO groups of the isocyanate component to form amine groups and CO₂ molecules. The release of CO₂ entails expansion of the foam.

In the second step, the amine groups obtained from the first step react with the −NCO groups to form urea groups.

In parallel, during the third step, the hydroxyl groups of the polyol component react with the −NCO groups to form urethane groups.

Lastly, in the fourth step, the trimerization step, the excess −NCO groups combine in threes to form iso-cyanurate groups.

The steps are exothermic and give rise to the expansion of the CO₂ and hence the expansion of the foam.

The formulation obtained from the mixture of the isocyanate component, the polyol component and various additives is immediately poured onto a stack of glass fibers comprising a defined thickness or a defined number of glass fiber mats, before the aforementioned reactions commence.

When the reaction commences it does not become visible macroscopically until after a certain period, referred to as the cream time.

The cream time is adjusted via the nature and concentration of catalysts such that the reaction commences only after total and homogeneous impregnation of the glass fiber stack or glass fiber mats by the formulation. The cream time is generally between 90 and 120 seconds.

Subsequently the reaction is manifested in a general expansion of the foam, brought about by the internal release of CO₂.

According to the present invention it is preferable to use an isocyanate component whose viscosity, as set out above, is preferentially between 200 and 600 mPa.s, preferably less than 300 mPa.s. The isocyanate compounds are of formula R(NCO)ₙ, in which n is >2 and R represents an aliphatic or aromatic group. Preference is given to using a diisocyanate, and more preferably a methylenediphenyl diisocyanate (MDI).

The functionality of the isocyanate component is preferably between 2.5 and 3.5 and advantageously between 2.7 and 3.1. The functionality is defined by the average number of −NCO groups present in each molecule of isocyanate component.

The percentage of −NCO groups, defined by the ratio by mass of −NCO groups/100 grams of isocyanate component, is advantageously between 28% and 32%.

Crude or undistilled methylenediphenyl diisocyanate may customarily be employed. This product is customarily available on the market under the brand name Suprasec, sold by Huntsman.

In the context of the present invention the polyol component comprises a mixture of three polyols, whose viscosity is between 200 and 6000 mPa.s.

The viscosity of the polyol component is preferably between 1000 and 3000 mPa.s.

The reactivity of the polyols is defined by different parameters, such as functionality, OH index, and aromaticity.

The preferred polyols have a functionality of between 2 and 6.

The hydroxyl index (OH index) of the polyols advantageously employed, defined by the mass ratio (mg KOH/g of polyols), is advantageously between 200 and 500 mg KOH/g polyols.

Determining the OH index makes it possible to assess the crosslinking efficiency of the formulation.

Representative examples of polyols derived from sorbitol are, for example, the polyols of the brand name Daltolac from Huntsman. The OH index is preferably 500 for the polyol derived from sorbitol.

Representative examples of polyether polyols are, for example, the products derived from glycerol whose side chains are extended with propylene oxide, such as those sold by Shell Chemicals under the brand name Caradol. The OH index is preferably 250 for the second polyol.

Representative examples of polyester polyols are aliphatic polyester polyols or, preferably, aromatic polyester polyols such as derivatives of phthalic anhydride. In the context of the present invention, derivatives of diethylene glycol ortho-phthalate, such as the product sold by Stepan under the brand name StepanPol, are employed with preference. The OH index is preferably 250 for the third polyol.

The advantage of using a polyester polyol, which is generally employed in the production of polyurethane foams, makes it possible to obtain a PUIR foam which exhibits substantial mechanical characteristics under heat and substantial flammability resistance characteristics.

The advantage of using a polyether polyol, which is generally employed in the production of poly-isocyanurate foams, lies in the fact that this type of polyol gives the PUIR foam improved mechanical strength under cold and improved impregnation, by the formulation, of the glass fiber stack or stack of glass fiber mats.

Furthermore, in the context of the present invention, the isocyanate index, defined above, depends on the proportions of isocyanate components and polyols introduced into the formulation.

When the isocyanate index is between, approximately, 95 and 110, the foam obtained from this formulation is a polyurethane (PU) foam. When the isocyanate index is greater than 200, i.e., when there is an excess of −NCO groups, the foam obtained from this formulation is a polyisocyanurate (PIR) foam. When the isocyanate index is between 110 and 200, the foams obtained from the formulation have characteristics both of a polyurethane foam and of a polyisocyanate foam, and are referred to as polyurethane/polyisocyanurate (PUIR) foams.

In the context of the present invention, the formulation further comprises additives which are customarily used in the preparation of PUIR foams, such as one or more catalysts, blowing agents, emulsifiers, and flame retardants.

The catalysts may be gelling catalysts, expansion catalysts, curing catalysts, and trimerization catalysts which are customarily employed in the production of PUIR foams. Catalysts which are particular advantageous in the context of the present invention are, for example, organometallic catalysts such as stannic catalysts, for example, tin(IV) carboxylates, especially tin octanoate, and potassium carboxylates, especially potassium octanoate. Tertiary amines may also be employed.

Advantageously, tin-based catalysts and potassium octanoate catalysts are used simultaneously in the absence of amine-type catalysts.

The tin-based catalysts are, for example, those of the DBTDL type sold by Air Products under the brand name Dabco, and are advantageously used in a proportion of between 0.01% and 1% by mass of the total mass of the polyols (that is, of the polyol component).

The potassium octanoate catalysts are, for example, those sold by Air Products likewise under the brand name Dabco and are used advantageously in a proportion of between 0.1% and 2% by mass of the total mass of polyols.

The amine-type catalysts are, for example, those sold by Air Products under the brand name Polycat and are used advantageously in a proportion of between 0.01% and 1% by mass of the total mass of polyols.

The catalysts are used in order to accelerate one or more of the different aforementioned reaction steps. For example, the stannic catalysts and tertiary amines act preferably on steps 1 to 3, whereas the potassium octanoate catalysts act preferably on the trimerization reaction (step 4).

The amount and identity of the catalysts introduced into the formulation directly influence the rate of the reaction and hence the cream time.

The proportions of catalysts introduced, however, may vary. The reason for this is that, when the grammage or the proportion of binder within the glass fiber stack or stack of glass fiber mats increases, the proportion of catalysts introduced into said formulation must be lowered in order to retard the cream time, so that said formulation is able to impregnate the glass fiber stack or stack of glass fiber mats uniformly before the reaction commences.

Consequently, the reactivity and viscosity of the formulation depend on the reactivity of the polyo-ls, but also on the amount and identity of the catalysts. The formulation further comprises one or more blowing agents, which may be physical or chemical.

The physical blowing agents preferably employed are nonchlorinated pentafluorobutane compounds and in particular 1,1,1,3,3-pentafluorobutane, also known under the name HFC-365mfc, especially of the brand name Solkane 365, sold by Solvay and HFC-245fc, of the brand name Enovate 3000, which is sold by Honeywell.

The chemical blowing agent preferably employed is water.

The abovementioned physical and chemical blowing agents may be used individually or at the same time.

The preferred amount of physical blowing agent is calculated as a function of the desired density of the reinforced PUIR foam. The amount is preferably between 0 and 10%, preferably around 5%, by mass relative to the total mass of the polyol component.

The preferred amount of water employed depends on the total desired density of the PUIR foam. The proportion of water in the composition is preferentially between 0 and 1%, preferably substantially 1%, relative to the total mass of the polyol component.

The blowing agents enable the foaming of the formulation. The identity of the blowing agents influences the thermal insulation properties of the foam. Water is used with preference as a blowing agent, since it gives rise to release of CO₂, which is a less environmentally harmful blowing agent than conventional blowing agents. Furthermore, CO₂ does not prevent the detection of any possible leak in the tank walls of the liquefied gas tanker.

Finally, it is preferable to use an emulsifier, which may be a silicone or nonsilicone emulsifier. An example of a silicone emulsifier is, for example, the emulsifier sold by Goldschmidt under the brand name Tegostab 8804. This type of emulsifier is advantageously employed in the formulation at approximately 1% by mass of the total mass of polyols. An example of a nonsilicone emulsifier is, for example, the emulsifier sold by Goldschmidt under the brand name LK443. This type of emulsifier is advantageously employed in the formulation in proportions of between 0.5% and 3% by mass of the total mass of polyols.

The emulsifiers are used in order to dissolve the blowing agent and to stabilize the cells.

In addition to the critical components mentioned above, it is often desirable to employ other components in the formulation of the present invention.

A flame retardant is also used with advantage in the context of the present invention, so as to limit further the flammability of the foam. The flame retardant may be halogenated—for example, TCPP, sold for example by Akzo Nobel—or, preferably, non-halogenated—for example, of the Levagard-TEP type from Lanxess. The flame retardant is preferably used in proportions of approximately 5% to 20% by mass of the total mass of polyols.

Other additives, such as fillers, crosslinkers, and dyes, may advantageously be added to the formulation.

Once the formulation obtained from the mixture of the isocyanate, polyols, and various additives has been prepared, it is rapidly poured onto a glass fiber stack or a stack of glass fiber mats, in such a way that the formulation impregnates the total thickness of the glass fiber stack or stack of glass fiber mats. The reinforced foam thus obtained has an average density of 115 to 135 kg/m³ and preferably of 120 to 130 kg/m³, more advantageously around 130 kg/m³.

The glass fiber mats used with preference according to a first embodiment are composed of continuous glass fiber mats (continuous strand mats), which are sold in particular by Vetrotex under the brand name Unifilo or by Owens Corning under the brand name Advantex.

These glass fibers are assembled with one another by means of a binder, which is present preferably in an amount of 0.6% to 3% by mass of the total mass of the glass fiber mat, and preferably substantially around 2.5%. The binder used for sizing the glass fibers is preferably an epoxy resin.

The glass fibers making up the mats employed with preference have a linear density of 20 to 40 tex, i.e., 20 to 40 g/km of fiber.

The glass fiber mats have a grammage of preferably between 300 and 900 g/m² and more advantageously between 300 and 600 g/m², more preferably in the region of 450 g/m². The glass fibers make up preferably 6% to 12% by mass relative to the total mass of the reinforced PUIR foam.

Depending on the amount of binder and on the grammage of the glass fiber mats, and so as to obtain acceptable mechanical properties, the number of glass fiber mats varies for example from 4 to 12.

The glass fibers used with preference according to a second embodiment are produced advantageously from roving—that is, a more or less wide, flat strip composed of glass fibers which are not twisted but are held parallel to one another. The glass fibers are preferably laid down in accordance with the Webforming process of Plastech T.T. Ltd.

The glass fibers laid down by this process have a linear density, preferably, of 30 to 300 tex.

FIGS. 1 to 3 illustrate the Webforming process of Plastech T.T. Ltd.

FIG. 1 shows a spool 1 of roving 2. Spool 1 is mounted about a rotation shaft 3, which extends along an axis of rotation A. Roving 2 is wound around spool 1. The end surfaces of spool 1, which are situated in a plane perpendicular to the axis of rotation A, are called longitudinal ends 11 and 13. One of the so-called distal ends 31 of rotation shaft 3 extends from longitudinal end 11 in the opposite direction to the center of spool 1 and traverses in succession a support 4 and a rotational drive motor 5.

Support 4 consists of two plates 41 and 42, which are joined to a foot 43 at the bottom part (in the sense of the drawing) of their radially outer surface, by means of support rods 44.

Rotational drive motor 5 is in the form of a case having the overall form of a disk and containing a servomotor (not shown). Rotational drive motor 5 is preferably equipped with a dynamic braking system (not shown), which is controlled by a computer system (not shown). The driving speed of motor 5 is advantageously controlled by a computer system (not shown).

Spool 1 serves to unwind roving 2 at a speed controlled by the dynamic braking system.

FIG. 2 shows a motorized supply capstan 9. Capstan 9 comprises a rotational drive motor 6, which is in the form of a case having the overall form of a disk. Motor 6 drives a rotation shaft 7 which extends along an axis of rotation B.

The end surfaces of motor 6, which are situated in a plane perpendicular to the axis of rotation B, are called longitudinal ends 61 and 63. One of the so-called distal ends 71 of rotation shaft 7 extends from longitudinal end 61 in the opposite direction to the center of motor 6. Distal end 71 traverses in succession the top part 81 of a support 8 and ends opposite the middle of the top part (in the sense of the drawing) of the central element 101 of a tension regulator 10, via a drive disk 72.

The driving speed of motor 6 and hence the rotational speed of rotation shaft 7 is advantageously controlled by a computer system (not shown).

Support 8 consists of a plate extending perpendicularly to the axis of rotation B. It comprises a bottom part 82 through which there are three fixing apertures 83. Bottom part 82 is combined with a hanger 85 for attachment to a support, which is not shown. The support has a rounded top part 81 through which there is a passage aperture 84. Passing through passage aperture 84 is longitudinal end 61 of motor 6. Support 8 allows the alignment of motor 6 to be maintained and hence the position of drive disk 72 to be maintained.

Tension regulator 10 contains aforementioned central element 101, which is composed of two parallel plates extending perpendicularly to the axis of rotation B. The two plates, 101a and 101b, are separated by spacers 107. Central element 101 further contains a distribution arm 102, a distancing arm 103, a front tensioning arm 104, and a rear tensioning arm 105.

Distribution arm 102 extends radially respectively toward the front (relative to the drawing). Distribution arm 102 contains a distribution aperture 102a at its radially outer end.

Distancing arm 103 extends radially toward the rear (relative to the drawing).

Front tensioning arm 104 extends upward (relative to the drawing) from the front of the middle of the top part of central element 101. Rear tensioning arm 105 extends upward (relative to the drawing) from the rear of the middle of the top part of central element 101. Front and rear tensioning arms 104 and 105 have a cylinder, 104a and 105a, at their radially outer end, said cylinders extending respectively along an axis (not shown) which is parallel to the axis of rotation B.

FIG. 3 is a schematic representation of the production line for glass fibers 15 from roving 2, in accordance with the Webforming process defined earlier.

In accordance with FIG. 3, roving 2 is routed continuously from spool 1 to capstan 9. In accordance with FIG. 2, the roving (which is not shown in FIG. 2) passes between the top part of cylinder 105a, the bottom part of drive disk 72, and the top part of cylinder 104a. The roving then traverses distribution aperture 102a. Drive disk 72, which is in frictional engagement with the roving, causes the roving to unwind and allows its speed to be regulated. As indicated earlier, the unwind speed of roving 2 is controlled by a computer system (not shown).

According to FIG. 3, the production line for glass fibers 15 comprises, upstream, spool 1 (represented schematically by a rectangle), which distributes roving 2 to capstan 9 (represented schematically by a rectangle) at a set speed. Capstan 9 carries out finer regulation of the speed and tension of roving 2. Finally, roving 2 is guided toward the entrance of distributor head 11 (represented schematically by a rectangle) . Distributor head 11 is arranged opposite the top part of conveyor belt 12. The linear density of roving 2 is between 1000 and 3000 tex, preferably around 2400 tex. Within distributor head 11, roving 2 is separated into glass fibers 15 having a low linear density of advantageously between 30 and 300 tex. The separation of roving 2 into low linear density glass fibers 15 is effected by means of differences in pressure and airflow within distributor head 11. The pressure and airflow are controlled by a computer system (not shown).

Moreover, distributor head 11 may be induced to move in translation along the axes X (shown) and Y (as defined earlier) in such a way as to distribute the glass fibers with a disordered orientation or in accordance with patterns and in a uniform amount, along these directions and also along the thickness of the stack (axis Y, as defined earlier). The movement of distributor head 11 and its height above the conveyor belt are likewise controlled by the computer system (not shown). Accordingly the grammage of the stack can be controlled. In this embodiment too, the grammage is advantageously between 300 and 900 g/m². Moreover, glass fibers 15 make up preferably 6% to 12% by mass relative to the total mass of the reinforced PUIR foam.

Furthermore, distributor head 11 may additionally distribute binder at the same time as the glass fibers. The binder is present advantageously in an amount of 0 to 3% by mass of the total mass of the glass fiber stack. The binder used for sizing the glass fibers is preferably an epoxy resin.

Lastly, distributor head 11 preferably distributes glass fibers 15 at a rate of 3 kg/min. A plurality of distributor heads 11, preferably 3, may be used in order to obtain such a rate.

To conclude, the quality of impregnation of the glass fiber stack according to the first or second embodiment depends on the reactivity and viscosity of the formulation, but also on the amount of binder employed.

The process for producing the PUIR foam proceeds advantageously as follows. The various components of the formulation may be mixed in a mixer of low-pressure rigid-foam mixer type.

In order to facilitate processing, however, the blowing agent and the various additives are generally introduced into the container holding the polyol component. Then the mixture containing the polyol component and the various additives are subsequently mixed into the isocyanate component, and the formulation obtained by this mixing operation is poured onto a glass fiber stack or stack of two or more glass fiber mats. The blowing agent and certain additives or catalysts may be added to the composition after mixing of the polyol component and the isocyanate component.

Preferably, when a reinforced PUIR foam is produced on the large scale, the glass fiber stack or stack of glass fiber mats is moved continuously (in the direction of the length of the foam) on a conveyor belt equipped with side walls. The container tipping the formulation onto the glass fiber stack or stack of glass fiber mats moves sideways (in the direction of the width of the foam) over the entire width of the conveyor belt between the side walls (referenced by 12 and 16, respectively, in FIG. 3). The side walls allow the formulation tipped into the glass fiber stack or stack of glass fiber mats to be contained, so as to produce uniform impregnation.

The various components of the formulation are mixed at ambient temperature and atmospheric pressure. Similarly, the formulation is preferably tipped onto the glass fiber stack or stack of glass fiber mats at ambient temperature and at atmospheric pressure.

The various components incorporated into the formulation used to impregnate the glass fiber stack or stack of glass fiber mats then begin to react after a period of time, which is referred to as the cream time.

Reaction continues and is manifested in foaming of the formulation which impregnates the glass fiber stack or stack of glass fiber mats.

The deposition rate is calculated, in accordance with the knowledge of the skilled worker, as a function of the speed of the conveyor, the block height, and the desired density.

The blocks of reinforced PUIR foam then dry for a time of between 5 and 10 minutes. The blocks of reinforced PUIR foam advantageously have a thickness of 25 or 35 cm.

The top and bottom parts, and where appropriate side parts, of the foam, now in the form of a reinforced foam block, are then removed. This trimming step makes it possible to produce foam blocks of given dimensions —for example, of 9 and/or 18 cm.

When these PUIR foam blocks are intended for insulating tanks of liquefied gas tankers, said foam blocks are then cut transversely to a third of their thickness, in order to make up the two—primary and secondary—insulating layers. In this case, a foam block 30 cm thick is trimmed and cut so as to form, simultaneously, foam blocks with thicknesses of 9 cm and 18 cm, so as to form, respectively, the primary and secondary insulating layers. This single cutting step from a single foam block makes it possible to obtain a primary insulating layer and a second insulating layer simultaneously, which constitutes not only a saving of material, since there are fewer trimming losses, but also a saving in time, since a single step is required for the manufacture of two thermal insulating layers.

The examples which follow are given in order to illustrate the invention and should not be interpreted as limiting it in any way whatsoever. Unless indicated otherwise, all percentages are given by mass.

The examples below illustrate the results of
Z compression tests (that is, compression tests in the thickness of the reinforced foam), under heat and under cold, which simulates the pressure on the side walls of tanks which is generated by the movement of the liquefied gas within the tank;
Y tensile tests (that is, tensile tests in the length of the reinforced foam composition), under heat and under cold, which simulate the deformations exerted within the wall of the tank and especially the elongation-type deformations due to the dilation and contraction of the tank walls when liquid gas is loaded and unloaded; and
flammability tests.

When the Z compression and Y tensile tests take place “under heat”, they proceed at ambient temperature. When these tests take place “under cold”, they take place within a cryostat in which the temperature is −170° C. (using liquid nitrogen).

On the industrial scale, these tests are carried out on 30 to 50 samples per block of foam obtained.

The Z compression tests are conducted in accordance with the standard ASTM D 1621 (or equivalent).

The compressive strength is evaluated by measuring the pressure applied vertically to the surface of each of the specimens, as a function of the displacement of the surface relative to its initial position in the direction of the thickness of each specimen. These measurements are plotted on a compressive strength curve (not shown) . The maximum pressure applied before the structure of the reinforced foam ruptures (the maximum on said curve) corresponds to the maximum compressive strength, which is denoted hereinafter by “Z compression”.

The slope of said curve corresponds to the elasticity modulus and is denoted hereinafter by “compression modulus”.

Depending on applications, it might be desirable to use foams exhibiting high Z compression and a low Z compression modulus.

The Y tensile tests are conducted in accordance with standard ASTM D 1623 (or equivalent).

The tensile strength is evaluated by measuring the resistance to the tensile force applied on opposite ends in the direction of the length of the specimens, as a function of the displacement of said ends relative to their initial position. These measurements are plotted on a tensile strength curve (not shown) . The maximum Y tensile force applied before the structure of the reinforced foam ruptures (the maximum on said curve) corresponds to the maximum tensile strength, which is denoted hereinafter as “Y tensile”.

The slope of said curve corresponds to the Y tensile elasticity modulus.

According to the applications, it might be desirable to use foams exhibiting a high Y tensile strength and a low Y tensile elasticity modulus.

It is important to note that similar tests may be implemented in order to measure the X tensile strength (that is, the tensile strength in the direction of the width of the reinforced PUIR foam). However, only Y tensile strength tests are presented hereinafter, since obtaining results which pass the criteria imposed for application to tanks of liquefied gas tankers is more difficult for Y tensile tests than for X tensile tests. This difference in results is due to the intrinsic characteristics of glass fiber mats which are commonly sold.

The influence of the composition of the PUIR foam on the Z compressive strength is studied below.

The formulation of different compositions of reinforced PUIR foam is shown in table I below.

TABLE I
Formulation of different PUIR foam compositions

| | | | | | | | | Component 3 | |
|---|---|---|---|---|---|---|---|---|---|
| Component 1 | | | | | | | | Blowing agent | |
| | | | | | | Flame | Component 2 | | Physical |
| Polyol 1 | Polyol 2 | Polyol 3 | Catalyst 1 | Catalyst 2 | Emulsifier | retardant | Isocyanate | Water | agent |

Processing temperature: 20 to 30° C.

| Viscosity | 3000-5000 | 200-400 | 4000-6000 | — | — | — | — | 170-300 | — | — |
|---|---|---|---|---|---|---|---|---|---|---|
| (mPa · s) | | | | | | | | | | |
| OH index | 500 | 250 | 245 | | | | | | — | — |
| Identity | Sorbitol | Polyether | Polyester | Sn-based⁴ | K octanoate | Silicone | TCPP | MDI⁷ | | Fluoro |
| | derivative¹ | type² | type³ | | type⁵ | type⁶ | | | | alkane⁸ |
| Composition 1 | Isocyanate index: 110 | | | | | | | | | |
| % by weight* | 70 | 10 | 20 | 0.01 | 0 | 0.9 | 10 | 130 | 0.91 | 0 |
| Composition 2 | Isocyanate index: 110 | | | | | | | | | |
| % by weight* | 70 | 20 | 10 | 0.01 | 0 | 0.9 | 10 | 130 | 0.91 | 0 |
| Composition 3 | Isocyanate index: 130 | | | | | | | | | |
| % by weight* | 70 | 10 | 20 | 0.01 | 0.5 | 1 | 10 | 158 | 1.10 | 0 |
| Composition 4 | Isocyanate index: 130 | | | | | | | | | |
| % by weight* | 60 | 20 | 20 | 0.01 | 0.5 | 1 | 10 | 150 | 1.10 | 0 |
| Composition 5 | Isocyanate index: 130 | | | | | | | | | |
| % by weight* | 60 | 20 | 20 | 0.01 | 0.5 | 1 | 10 | 150 | 0.37 | 6 |
| Composition 6 | Isocyanate index: 190 | | | | | | | | | |
| % by weight* | 60 | 0 | 40 | 0.01 | 1 | 1.15 | 10 | 205 | 1.25 | 0 |
| Composition 7 | Isocyanate index: 110 | | | | | | | | | |
| % by weight* | 80 | 20 | 0 | 0.01 | 0.5 | 0.9 | 10 | 138 | 0.91 | 0 |

*relative to the total mass of polyols
¹Daltolac R500 from Huntsman
²Caradol ET250-02 from Shell Chemical
³Stepanpol 2352 from Stepan
⁴DBTDL Dabco T12N from Air Products
⁵Dabco K15 from Air Products
⁶Tegostab 8804 from Goldschmidt
⁷Suprasec 5005 from Huntsman
⁸Solkane 365mfc from Solvay

The various elements of component 1 of table I are mixed uniformly. Then components 2 and 3 are added in succession to component 1. The resulting formulations are run onto a stack of 8 glass fiber mats in such a way that the reinforced PUIR foam has a fiber content of 9% and a density of 130 kg/m³. In these tests, the grammage and binder content of the glass fiber mats are 450 g/m² and 0.8% respectively.

Following stabilization, Z compressive strength tests under heat and under cold are carried out, on the laboratory scale, on each of the above compositions.

The results of these tests are presented in table II below. All of the values presented relate to foam compositions for which the density value has been extrapolated to 130 kg/m³, in order to allow comparison of their mechanical properties. This extrapolation is possible since the relation between the density and the mechanical properties of the reinforced foam compositions is linear within this density range.

The measurements of the proportion of closed cells in accordance with standard ASTM D 2856 (procedure B) and flammability tests in accordance with standard DIN 4102-1 were also carried out on each of the above formulations.

In all of the tables below, the results presented are an average of the values obtained from all of the specimens tested.

TABLE II
Results of Z compression tests on different PUIR foam compositions

| Composition | Specification | 1 | 2 | 3 | 4 | 5 | 6 | 7 |
|---|---|---|---|---|---|---|---|---|
| Isocyanate | — | 110 | 110 | 130 | 130 | 130 | 190 | 110 |
| index | | | | | | | | |
| Flammability | DIN 4102-1 | B3 | B3 | B2 | B2 | B2 | B2 | B3 |
| Proportion | >92% | 92 | 92.2 | 93 | 94 | 94 | 93 | 93 |
| of closed | | | | | | | | |
| cells | | | | | | | | |
| Under heat | | | | | | | | |
| (20° C.) | | | | | | | | |
| Z | Greater than | 1.6 | 1.52 | 1.73 | 1.65 | 1.61 | 1.75 | 1.6 |
| compression | 1.6 | | | | | | | |
| (MPa) | | | | | | | | |
| Z | Between 50 | 75 | 71 | 75 | 69 | 71 | 76 | 73 |
| compression | and 80 | | | | | | | |
| modulus | | | | | | | | |
| (MPa) | | | | | | | | |
| Under cold | | | | | | | | |
| (−170° C.) | | | | | | | | |
| Z | Greater than 3 | 3.7 | 3.5 | 3.2 | 3.4 | 3.2 | 2.35 | 3.2 |
| compression | | | | | | | | |
| (MPa) | | | | | | | | |
| Z | Less than 130 | 117 | 120 | 125 | 126 | 128 | 117 | 136 |
| compression | | | | | | | | |
| modulus | | | | | | | | |
| (MPa) | | | | | | | | |

B3: does not meet the criteria of standard DIN 4102-1
B2: meets the criteria of standard DIN 4102-1

In table II and the tables below, the results which do not meet the criteria imposed for application to tanks of liquefied gas tankers are shown in bold. The column “Specification” shows, in table II, all of the criteria on the laboratory scale imposed by the applicant company for application to tanks of liquefied gas tankers.

Under heat (20° C.), all of the compositions give Z compressive strength results which are satisfactory overall. However, for application to tanks of liquefied gas tankers, compositions 3 and 4, with an isocyanate index of 130, exhibit the best results.

Under cold (−170° C.) all of the compositions, with the exception of composition 6, whose isocyanate index is very much greater than the isocyanate index claimed, and which contains only two polyols, exhibit a Z compressive strength of greater than 3 MPa.

It is interesting to note that the formulations with an isocyanate index of 110 exhibit good mechanical strength but a flammability resistance which is lower than that of compositions with a higher isocyanate index.

To conclude, in order to obtain the best compromise between the hot and cold compressive strength characteristics and the flammability resistance characteristics, it appears that three polyols are required for the composition according to the present invention.

Furthermore, composition 4, which incorporates 60% of first polyol, 20% of second polyol, and 20% of third polyol, relative to the total mass of the polyol component, is the composition with provides the best impregnation of the glass fiber mats, giving rise to improved homogeneity of the reinforced PUIR foam.

The influence of the characteristics of the glass fiber mats and of the total density of the reinforced PUIR foam in Z compressive strength and Y tensile strength is studied below.

Different reinforced PUIR foam compositions, studied on the industrial scale, are shown in table III below.

TABLE III
Composition of different reinforced PUIR foams

| | | | Number of | Grammage | |
|---|---|---|---|---|---|
| | Average | | layers of | of glass | |
| | density | Proportion | glass fiber | fiber mats | Binder |
| Composition | (kg/m³) | of fibers* | mats | (g/m²) | content* |
| 8 | 123 | 11.1 | 10 | 450 | 2.5 |
| 9 | 132.5 | 7.6 | 8 | 450 | 2.5 |
| 10 | 131.5 | 11.1 | 7 | 600 | 0.8 |
| 11 | 132.5 | 10.1 | 8 | 600 | 2.5 |
| 12 | 131 | 11.3 | 10 | 450 | 2.5 |

*% by mass relative to the total mass of the reinforced foam

The various compositions 8 to 12 above are based on earlier composition 4, but incorporate fiber mats having different characteristics in terms of grammage, binder content, proportion of fibers, and number of layers of glass fibers.

The average density and all of the results which follow are calculated by averaging the results obtained at all levels of the reinforced PUIR foam in the direction of thickness (bottom, middle, and top).

The Z compressive strength tests and Y tensile strength tests under heat are presented in table IV below. The column “Specification” presents, below, all of the criteria, on the industrial scale, which were imposed by the applicant company for application to tanks of liquefied gas tankers.

TABLE IV
Z compressive strength and Y tensile strength tests
under heat (20° C.)

| | Specification | | | | | |
|---|---|---|---|---|---|---|
| Composition | (MPa) | 8 | 9 | 10 | 11 | 12 |
| Z | Greater than | 1.42 | 1.47 | 1.72 | 1.62 | 1.65 |
| compression | 1.5 | | | | | |
| (MPa) | | | | | | |
| Deviation | As small as | 0.17 | 0.12 | 0.11 | 0.23 | 0.2 |
| (in MPa)* | possible | | | | | |
| Z | Less than 80 | 60 | 65 | 70 | 75 | 70 |
| compression | | | | | | |
| modulus | | | | | | |
| (MPa)* | | | | | | |
| Deviation | As small as | 10.9 | 8.2 | 7.3 | 9.1 | 6.0 |
| (in MPa)* | possible | | | | | |
| Y tensile | Greater than | 2.95 | 2.2 | 2.55 | 3.1 | 3.2 |
| (MPa) | 2.4 | | | | | |
| Deviation | As small as | 0.95 | 0.72 | 0.23 | 0.65 | 1.2 |
| (in MPa)* | possible | | | | | |
| Y tensile | Less than | 122 | 92 | 112 | 125 | 133 |
| modulus | 150 | | | | | |
| (MPa) | | | | | | |
| Deviation | As small as | 40.5 | 51 | 20 | 48 | 35 |
| (in MPa)* | possible | | | | | |

*Deviation: deviation between the specimens of a single composition that exhibit the smallest and the largest result

The Z compressive strength and Y tensile strength test results under cold are presented in table V below.

TABLE V
Z compressive strength and Y tensile strength tests under
cold (−170° C.)

| | Specification | | | | | |
|---|---|---|---|---|---|---|
| Composition | (MPa) | 8 | 9 | 10 | 11 | 12 |
| Z compression | Greater than | 2.65 | 2.71 | 2.87 | 3.12 | 2.95 |
| (MPa) | 2.7 | | | | | |
| Deviation | As small as | 0.31 | 0.23 | 0.33 | 0.7 | 0.26 |
| (in MPa)* | possible | | | | | |
| Z compression | Less than 130 | 116 | 111 | 120 | 125 | 113 |
| modulus (MPa) | | | | | | |
| Deviation | As small as | 21 | 26 | 12 | 18 | 22 |
| (in MPa)* | possible | | | | | |
| Y tensile | Greater than | NM | 2.65 | 1.6 | 3.41 | 3.4 |
| (MPa) | 2.7 | | | | | |
| Deviation | As small as | NM | 0.71 | 1.14 | 0.85 | 1.75 |
| (in MPa)* | possible | | | | | |
| Y tensile | Less than 190 | NM | 177 | 152 | 215 | 167 |
| modulus (MPa) | | | | | | |
| Deviation | As small as | NM | 58 | 40 | 61 | 42 |
| (in MPa)* | possible | | | | | |

NM: not measured
*Deviation: deviation between the specimens of a single composition that exhibit the smallest and the largest result

Although all of the formulations give satisfactory 10 results overall in terms both of Y tensile strength and Z compressive strength, it is formulation 11 which, overall, exhibits the best average performances under heat and under cold.

It should, however, be noted that, under heat, formulation 9, whose fiber content is the lowest (7.6%), leads to performances which are slightly lower under heat.

Moreover, formulation 10, whose binder content is the lowest (0.8%), leads to performances which are slightly lower under cold.

Similarly, formulation 8, whose density is the lowest, exhibits performances which are slightly lower under heat and under cold.

The formulations of the present invention exhibit a favorable compressive strength/modulus ratio, of the order of 35 to 45. This characteristic gives the reinforced PUIR foam an excellent balance between strength and flexibility.

Finally, the measurement of the quality of the foam via the measurement of the proportion of closed cells in accordance with standard ASTM D 2856 (procedure B) and flammability tests in accordance with standard DIN 4102-1 were also carried out on each of the above formulations, and are presented in table VI below.

TABLE VI
Measurement of proportion of closed cells, and
flammability tests

| Composition | Specification | 8 | 9 | 10 | 11 | 12 |
|---|---|---|---|---|---|---|
| Average foam | — | 123 | 122 | 131.5 | 132.5 | 131 |
| density (in | | | | | | |
| kg/m³)* | | | | | | |
| Deviation | As small as | 8.3 | 9.5 | 5.8 | 11.0 | 8.8 |
| | possible | | | | | |
| Flammability | DIN 4102-1 | B2 | B2 | B2 | B2 | B2 |
| | (B2) | | | | | |
| Proportion of | >92% | 92 | 93 | 93 | 94 | 92 |
| closed cells | | | | | | |

*Deviation: deviation between the specimens of a single composition exhibiting the smallest and largest result

All of formulations 8 to 12 give very satisfactory results in terms both of flammability resistance and proportion of closed cells.

In conclusion, all of the above formulations exhibit very satisfactory mechanical strength characteristics and can be applied to technical fields such as construction, automotive, etc. The abovementioned formulations which additionally satisfy the criteria imposed by the applicant company can also be applied to tanks of liquefied gas tankers, a technical field in which the deformation and dilatation stresses are more significant.

Although the invention has been described in connection with a particular embodiment, it is readily apparent that it is in no way limited to that embodiment and that it embraces all of the technical equivalents of the means described, and of combinations thereof, which fall within the scope of the invention.

1. A glass fiber reinforced polyurethane/polyiso-cyanurate foam obtained by:
1) contacting:
an isocyanate component having a viscosity of between 200 and 600 mPa.s,
a polyol component comprising a first polyol, a second polyol, and a third polyol, said polyols having a viscosity of between 200 and 6000 mPa.s, in the presence of:
catalysts selected from tin salts, potassium carboxylates, and, optionally, tertiary amines,
a physical and/or chemical blowing agent,
an emulsifier, and
optionally a flame retardant,
2) impregnating, with the formulation obtained from step 1, a glass fiber stack, and
3) expanding and solidifying said formulation to form a reinforced foam block containing the glass fiber stack;
said reinforced foam block having an average density of between 115 and 135 kg/m³, preferably between 120 and 130 kg/m³, more advantageously around 130 kg/m³, and an isocyanate index of between 100 and 180, preferably between 130 and 180.

2. The foam as claimed in claim 1, wherein said isocyanate component is methylenediphenyl diisocyanate (MDI) having an average functionality of between 2.5 and 3.5, preferably between 2.9 and 3.1.

3. The foam as claimed in claim 1, wherein said first polyol is a sorbitol derivative, said second polyol is a polyether polyol, and said third polyol is a polyester polyol.

4. The foam as claimed in claim 1, wherein said polyol component is composed of said first, second, and third polyols, wherein said first polyol is present in proportions from 10% to 80% by mass relative to the total mass of said polyol component, wherein said second polyol is present in proportions from 10% to 80% by mass relative to the total mass of said polyol component, and wherein said third polyol is present in proportions from 10% to 80% by mass relative to the total mass of said polyol component.

5. The foam as claimed in claim 1, wherein the proportions by mass of the first, second, and third polyols relative to the mass of said polyol component are 60%, 20%, and 20% respectively.

6. The foam as claimed in claim 1, wherein the catalysts are selected from tin salts and potassium carboxylates to the exclusion of tertiary amines.

7. The foam as claimed in claim 1, wherein the blowing agent is water.

8. The foam as claimed in claim 1, wherein the blowing agent is HCF-365mfc or HCF-245fa.

9. The foam as claimed in claim 1, wherein said flame retardant is nonhalogenated.

10. The foam as claimed in claim 1, wherein said glass fiber stack is in the form of a stack of glass fiber mats.

11. The foam as claimed in claim 10, whose glass fibers have a linear density of 20 to 40 tex, preferably 30 tex.

12. The foam as claimed in claim 1, wherein said glass fiber stack comprises continuous glass fibers manufactured from roving.

13. The foam as claimed in claim 12, whose glass fibers have a linear density of 30 to 300 tex.

14. The foam as claimed in claim 12, wherein said continuous glass fibers are produced by a process comprising a step of separating continuous glass fiber roving whose linear density is less than that of the roving.

15. The foam as claimed in claim 1, wherein said glass fibers are associated with one another by a binder.

16. The foam as claimed in claim 15, wherein the amount of said binder is between 0.6% and 3%, preferably around 2.5% by mass of said glass fibers.

17. The foam as claimed in claim 12, wherein said glass fibers are not associated by a binder.

18. The foam as claimed in claim 1, wherein said glass fiber stack has a grammage of between 300 to 900 g/m², preferably 450 g/m².

19. The foam as claimed in claim 1, wherein the glass fibers constitute 7% to 13%, preferably 10% to 12% by mass of the total mass of the reinforced foam block.

20. The foam as claimed in claim 1, whose flammability is in accordance with the DIN 4102-1 (B2) test.

21. The foam as claimed in claim 1, in the form of a foam block with a thickness of between 20 and 35 cm.

22. A process for producing a glass fiber reinforced polyurethane/polyisocyanurate foam, comprising the steps of:
1) contacting:
an isocyanate component having a viscosity of between 200 and 600 mPa.s,
a polyol component comprising a first polyol, a second polyol, and a third polyol, said polyols having a viscosity of between 200 and 6000 mpa.s, in the presence of:
catalysts selected from tin salts, potassium carboxylates, and, optionally, tertiary amines,
a blowing agent,
an emulsifier
optionally a flame retardant,
2) impregnating, with the formulation obtained from step 1, a glass fiber stack,
3) causing said formulation to solidify after expansion, so as to form a foam block containing the glass fiber stack,
4) trimming the top, bottom, and, optionally, side parts of said foam block, and optionally
5) cutting said foam block transversely, to give a primary insulating layer and a secondary insulating layer.

23. The use of the foam as claimed in claim 1 in the thermal insulation of liquefied gas transport tanks, and especially of liquefied gas tanker tanks.
